(19) United States
(12) Patent Application Publication
(10) Pub. No.: US 2003/0140161 A1
(43) Pub. Date: Jul. 24, 2003

(54) Portable computing device having a dynamic client classmark and method therefor

(76) Inventor: Matthew A. Hayduk, Calgary (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/026,397

(22) Filed: Dec. 21, 2001

(51) Int. Cl. G06F 15/16

(52) U.S. Cl. 709/232; 709/228

(57) ABSTRACT

Briefly, in accordance with one embodiment of the invention, a portable computing or communication device dynamically generates a client classmark. The execution of applications on the device is altered depending on the client classmark.

### BACKGROUND

Mobile computing devices such as, for example, portable personal digital assistants allow a user to perform computing and/or communication functions from many locations and while the user is moving with the device. However, as a user moves about with the mobile computing device, the services that are available to the device may change. For example, the user may move in or out of a location that is serviced with different communication protocols (i.e. cellular, 802.11, etc.). Thus, the communication methods available to the device may change with time.

However, when applications are executed on mobile devices, they typically assume a minimum level of available services and functionality. Applications cannot adapt to reduced level of services or take advantage of changes in the level of services that may become available as the user moves with the mobile device.

Thus, there is a continuing need for better ways to execute applications on mobile computing devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1 is a block diagram representation of a mobile device in accordance with an embodiment of the present invention; and

FIG. 2 is a logical model of a mobile device in accordance with an embodiment of the present invention.

It will be appreciated that for simplicity and clarity of illustration, elements illustrated in the figure have not necessarily been drawn to scale. For example, the dimensions of some of the elements are exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

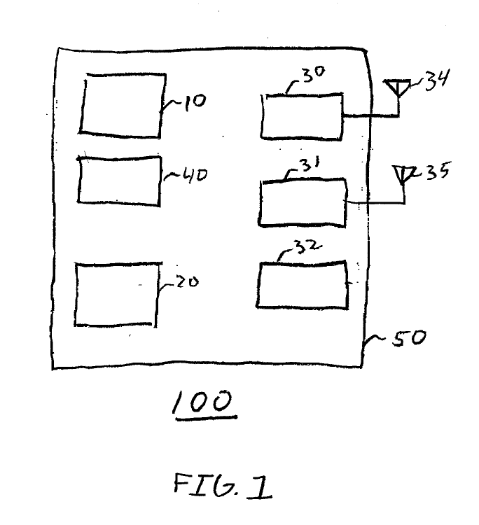

Turning to FIG. 1, an embodiment 100 in accordance with the present invention is described. Embodiment 100 may comprise a portable computing or communication device 50 such as a mobile communication device (e.g., cell phone), a two-way radio communication system, a one-way pager, a two-way pager, a personal communication system (PCS), a portable computer, or the like. Although it should be understood that the scope and application of the present invention is in no way limited to these examples. Other embodiments of the present invention may include other computing systems that may or may not be portable or even involve communication systems such as, for example, desktop or portable computers, servers, network switching equipment, etc.

In this particular embodiment portable computing device 50 may include a processor 10 that may execute instructions such as instructions stored in a memory 40. Processor 10 may be one of a variety of integrated circuits such as, for example, a microprocessor, a central processing unit (CPU), a digital signal processor, a microcontroller, a reduced instruction set computer (RISC), a complex instruction set computer (CISC), or the like, although the scope of the present invention is not limited by the particular design or functionality performed by processor 10. In addition, in some alternative embodiments, portable computing device 50 may comprise multiple processors that may be of the same or different type. For example, in another embodiment, portable computing device 50 may comprise a CISC processor to execute general user applications and a base band processor that may be used to initiate and receive wireless communications.

Portable computing device 50 may also comprise a display 20 (or other output devices) to provide information to a user and communication modules 30-32 to provide access to other devices, service, networks, etc. For example communication modules 30-32 may be used to allow portable computing device 50 to communicate with other devices networks through either a wired or wireless link. As shown, communication modules may use antennae 34-35 to wirelessly communicate with other networks.

Although the scope of the present invention is not limited in this respect, communication modules 30-31 may employ a variety of wireless communication protocols such as cellular (e.g. Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like).

In addition, communication modules may use other wireless local area network (WLAN), wide area network (WAN), or local area network (LAN) protocols such as the Industrial Electrical and Electronics Engineers (IEEE) 802.11 standard, Bluetooth™, infrared, etc. (Bluetooth is a registered trademark of the Bluetooth Special Interest Group).

It should be understood that the scope of the present invention is not limited by the types of, the number of, or the frequency of the of communication protocols that may be used by portable computing device 50. Furthermore, alternative embodiments may only have one communication module (either wired or wireless) and communication modules need not have separate antennae and some or all may share a common antennae.

Memory 40 may comprise any variety of volatile or non-volatile memory such as any of the types of storage media recited earlier, although this list is certainly not meant to be exhaustive and the scope of the present invention is not limited in this respect. Memory 40 may be used to store sets of instructions such as instructions associated with an application program, an operating system program, a communication protocol program, etc. For example, the instructions stored in memory 40 may be used to perform wireless communications, provide security functionality for portable computing device 50, user functionality such as calendaring, email, internet browsing, etc.

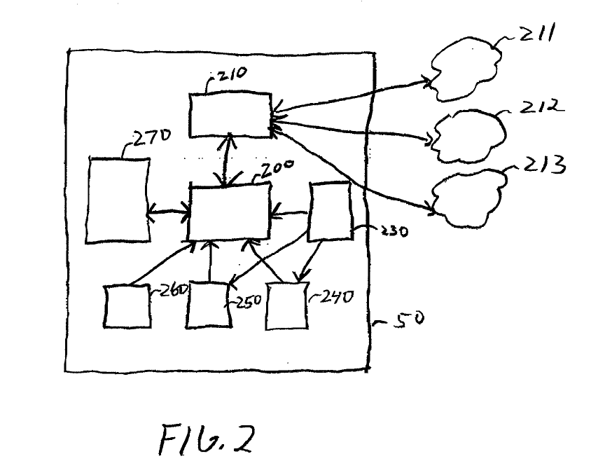

Turning to FIG. 2, a particular embodiment of the present invention is provided. FIG. 2 is a logical model diagram representing the relationships and interactions between operations that may take place within portable computing device 50. It should be understood that the operations illustrated may be implemented with any combination of hardware and software. In other embodiments, operations shown in FIG. 2 and/or discussed below may be implemented entirely in hardware or entirely in software. Furthermore, the portions of the operations that are implemented, at least in part, with software may be implemented through an operating system, user applications, firmware, etc., although the scope of the present invention is not limited to just these examples.

While in operation, portable computing device 50 may dynamically generate and maintain a client classmark 200. Classmark profile 200 may be a compilation of data that defines or indicates the current capabilities or attributes of portable computing device 50. Although the scope of the present invention is not limited in this respect, the capabilities or attributes may include the current physical capabilities, logical capabilities, the communication capabilities, processing capabilities, and/or user preferences for portable computing device 50.

Simply put, client classmark 200 may be a list that provides information regarding various aspects of the operation of portable computing device 50 so that the execution of applications or functionality may be altered or scaled to balance various performance traits. For example, the information provided by client classmark 200 may be used to alter how instructions (e.g. user applications) are executed to achieve a desired user defined performance level. The data may also be used to reduce the amount of power that may be consumed during the operation of portable computing device 50. Alternatively, client classmark 200 may be used to select the method with which portable computing device 50 communicates to consider such factors as cost, reliability, security, bandwidth, power consumption, Quality of Service (QoS), interference, etc., although the scope of the present invention is not limited in this respect.

Although the scope of the present invention is not limited in this respect, client classmark 200 may be stored or maintained in memory (volatile or non-volatile) within portable computing device 50. For example, the information that makes up client classmark 200 may be stored as a table in memory 40 (see FIG. 1). Alternatively, client classmark 200 may be stored or maintained in registers, cache(s), latches, or other circuitry.

In operation, portable communication device 50 may include a connection service discovery operation 210 that may be used to poll or query communication modules to determine what communication services are currently available. For example, connection service discovery operation 210 may poll communication modules 30-32 (see FIG. 1) to determine what communication techniques are currently available and the characteristics of those techniques (i.e. cost, reliability, bandwidth, etc.). For example, portable computing device 50 may be able to communicate with a cellular service 211, a wireless LAN (e.g. 802.11) 212, or through a wired connection 212.

As a user moves, the communication services available to portable computing device 50 may change with time. In addition, the level, cost, or quality of the service may also change. For example, the user may move or roam such that its communicates with a cellular system that is not part of its normal or low cost service network. Accordingly, although the scope of the present invention is not limited in this respect, connection service discovery module 210 may periodically update client classmark 200. Alternatively, connection service discovery module 210 may make the updates whenever there are changes in the communication services available (e.g. the user is no longer in range).

The information in client classmark 200 may be used by applications executing in portable computing device 50 to select a communication techniques that may be the most cost effective, most secure, fastest, consume the least amount of power, etc., although the scope of the present invention is not limited in this respect. The applications may also be able to dynamically makes changes as the user moves and the availability of particular communication methods changes.

Portable computing device 50 may also be adapted such that a user may be able to define some user preference. Such information may be tracked and provided by a user's preference module 230. Although the scope of the present invention is not limited to these examples, user preference module 230 may indicate particular performance levels desired by a user, indicate a desired Quality of Service (QoS) for operation, indicate a desired cost or security level for particular services or features, indicate a desired power consumption level, etc. This information may be used to indicate with client classmark 200 to prioritize what hardware or software should be used by application executing on portable communication device 50. This information may also be used to select or prioritize the communication method to be used by portable computing device 50 in various situations.

Portable computing device 50 may also have a physical services module 240 that may update client classmark 200 regarding the status or availability of particular hardware components (e.g. memory, cache, processing capabilities, input/output devices, etc.) within portable communication device 50. This information may provide the physical capabilities of portable computing device 50, which may be indicated through client classmark 200. This information may be used by applications executing within portable computing device 50 to select what hardware or software should be used during the execution of those applications. For example, the applications may select the memory to be used for caching or select the I/O device to receive and provide information, although the scope of the present invention is not limited in this respect.

Portable computing device 50 may also have a logical services module 250 that may update client classmark 200 regarding the status or availability of various logical services (e.g. virtual machine capabilities, synchronization, translators, mail services, etc.) within portable communication device 50. This information may provide the logical capabilities of portable computing device 50, which may be indicated through client classmark 200. This information may be used by applications executing within portable computing device 50 to select what logical services should be used during the execution of those applications.

Portable computing device 50 may also comprise a system load monitor 260 that may update client classmark 200 regarding the current usage or load level of components within portable computing device 50. Although the scope of the present invention is not limited in this respect, system load monitor 260 may comprise any combination of hardware and/or software that may track the historical or current load of components within portable computing device 50. For example, system load monitor 260 may track the current bandwidth (i.e. available processing capability—typically measured in millions of instructions per second (MIPS)) of processor 10 (see FIG. 1). Alternatively, system load monitor 260 may also track the usage of memory components, caches, or I/O devices in portable computing device 50. This information may then be reflected in client classmark 200. Since this information may be dynamically changing, system load monitor 260 may constantly or periodically update client classmark 200, although the scope of the present invention is not limited in this respect.

This information may be used by applications executing on portable computing device 50 to scale themselves, or other applications, so that instructions may be executed or features may be provided to a user within the desired performance parameters. For example, this information may be used to lower the voltage potential or clock rate of processor 10, and thus the power consumption, of portable computing device 50 if there is sufficient bandwidth available to execute applications within the user's expectations.

Applications 270, such as user applications, operating system applications, or firmware, may use the information available with client classmark 200 to adjust or scale their execution. For example, although the scope of the present invention is not limited in this respect, applications 270 may adjust their operation to enhance a user's experience. Alternatively, the execution of applications 270 may be altered to achieve a particular execution speed, power consumption, security level, etc. The information or list provided by client classmark 200 may also be used by one application executing on portable computing device to scale the operation of another application that may be executing. This may be desirable to share resources or prioritize requests made by the user.

Furthermore, as a user moves and operates portable computing device 50, the capabilities available may change. Accordingly, client classmark 200 may be dynamically generated, or alternatively, may be periodically updated, although the scope of the present invention is not limited in this respect.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile computing device comprising:
a processor; and
a memory, wherein the mobile computing device is adapted to dynamically generate a client classmark as the mobile computing device is moved.

2. The mobile computing device of claim 1, wherein the mobile computing device is further adapted to communicate using at a first and second communication service, the client classmark being generated depending, at least in part, on availability of the first and second communication service.

3. The mobile computing device of claim 1, further comprising a monitor adapted to track a load status of the processor.

4. The mobile computing device of claim 3, wherein the client classmark is generated, at least in part, on the load status of the processor.

5. The mobile computing device of claim 1, wherein the memory is adapted to store the client classmark.

6. A method comprising:
determining what communication services are available to a device; and
maintaing a client classmark for the device based upon what communication services are available.

7. The method of claim 6, further comprising:
polling to determine physical capabilities of the device, wherein maintaining the client classmark includes maintaining a client classmark for the device based upon the physical capabilities of the device.

8. The method of claim 6, further comprising:
polling to determine logical capabilities of the device, wherein maintaining the client classmark includes maintaining a client classmark for the device based upon the logical capabilities of the device.

9. The method of claim 6, further comprising:
defining user preferences, wherein maintaining the client classmark includes maintaining a client classmark for the device based upon the user preferences.

10. The method of claim 6, further comprising:
determining a current load of a processor in the device, wherein maintaining the client classmark includes maintaining a client classmark for the device based upon the current load of the processor.

11. The method of claim 6, further comprising:
adjusting the execution of an application on a processor in the device depending on the client classmark.

12. The method of claim 6, further comprising:
requesting with a first application executing on a processor in the device that a second application executing on the processor modify its operational characteristics.

13. The method of claim 1, further comprising storing the client classmark in a memory of the device.

14. An article comprising a storage medium having stored thereon instructions, that, when executed by a computing platform, results in:
polling to determine what communication services are available to the article; and
dynamically generating a client classmark for the article based upon what communication services are available.

15. The article of claim 15, wherein the instructions, when executed, further result:
polling to determine physical capabilities of the article, wherein dynamically generating the client classmark includes generating a client classmark for the article based upon the physical capabilities of the device.

16. The article of claim 15, wherein the instructions, when executed, further result:
polling to determine logical capabilities of the article, wherein dynamically generating the client classmark includes generating a client classmark for the article based upon the logical capabilities of the device.

17. The article of claim 15, wherein the instructions, when executed, further result:
defining user preferences, wherein dynamically generating the client classmark includes generating a client classmark for the article based upon the user preferences.

18. The article of claim 15, wherein the instructions, when executed, further result:
determining a current load of a processor in the article, wherein dynamically generating the client classmark includes generating a client classmark for the article based upon the current load of the processor.

19. The article of claim 15, wherein the instructions, when executed, further result:
adjusting the execution of an application on a processor in the article depending the client classmark.
